(19) United States
(12) Patent Application Publication
(10) Pub. No.: US 2024/0271449 A1
(43) Pub. Date: Aug. 15, 2024

(54) UNDERWATER LIDAR PRINCIPALLY FOR USE IN CONNECTION WITH SWIMMING POOLS OR SPAS

(71) Applicant: ZODIAC POOL CARE EUROPE, Belberaud (FR)

(72) Inventors: Simon Duffaut, Castelginest (FR); Mehdi Chafik, Tournefeuille (FR); Olivier Cam, Toulouse (FR)

(21) Appl. No.: 18/440,408

(22) Filed: Feb. 13, 2024

Related U.S. Application Data
(60) Provisional application No. 63/445,286, filed on Feb. 13, 2023.

(51) Int. Cl. E04H 4/16; G01S 7/481; G01S 7/4915; G01S 17/89

(52) U.S. Cl. CPC E04H 4/1654; G01S 7/4811; G01S 7/4817; G01S 7/4915; G01S 17/89

(57) ABSTRACT

Systems and methods utilize a time of flight (“ToF”) sensor system underwater and in connection with the use of robotic automatic swimming pool cleaners. The systems and methods described herein may take a plurality of measurements around the automatic swimming pool cleaner and/or in a plurality of directions relative to the automatic swimming pool cleaner. The systems and methods may allow for the automatic swimming pool cleaner to map the pool or spa, determine a cleaner path for the automatic swimming pool cleaner, determine if there are occupants in the pool, avoid obstacles within the pool or spa, and/or drive the automatic swimming pool cleaner to specific areas of the pool or spa, among other actions.

### REFERENCE TO RELATED APPLICATION

This application claims the benefit of U.S. Provisional Patent Application No. 63/445,286, filed on Feb. 13, 2023, and entitled UNDERWATER LIDAR PRINCIPALLY FOR USE IN CONNECTION WITH SWIMMING POOLS OR SPAS, the content of which is hereby incorporated by reference in its entirety.

### FIELD OF THE INVENTION

This invention relates to equipment principally for use in connection with water-containing vessels such as swimming pools and spas and more particularly, but not necessarily exclusively, to equipment, systems, and methods employing automatic swimming pool cleaners (“APCs”) with time of flight (ToF) systems within the vessels.

### BACKGROUND OF THE INVENTION

Numerous cleaning devices capable of autonomous movement within swimming pools and spas currently exist. The most common of these devices are APCs, which often are either hydraulic or robotic in type. Hydraulic cleaners vary water flow for movement, while robotic cleaners typically employ electric motors to cause motion. Hydraulic APCs, furthermore, subdivide into “pressure-side” and “suction-side” cleaners, with pressure-side cleaners being fluidly connected to outputs of pumps of pool water circulation systems and suction-side cleaners being fluidly connected to inputs of such pumps. International Patent Application Publication No. WO 2020/041075 of Newman, et al., whose contents are incorporated herein in their entirety by this reference, describes mapping and tracking methods and systems for use in connection with pools and spas. Included as part of these systems may be an apparatus for light detection and ranging (“LIDAR”) having a rotating sensor. The sensor projects above the waterline of a pool “so as to send laser light through air, rather than water,” and the apparatus may be tethered to an APC travelling within the pool. In use, the sensor “collects data as it scans the walls forming the perimeter of a pool at and above the waterline.”

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, an APC or docking station includes a ToF sensor system configured to perform continuous measuring about at least one axis underwater and about an angle greater than 0°.

According to various embodiments, an APC or docking station includes a ToF sensor system configured to perform 360° measuring about three axes while underwater.

According to some embodiments, a method of mapping a pool or spa includes moving an APC or docking station within the pool or spa, where the APC or docking station includes a ToF sensor system configured to perform 360° measuring about three axes while underwater.

According to some embodiments, a method comprising locating an APC or docking station within a swimming pool or spa based on ToF measuring performed in 360° about three axes.

According to various embodiments, a method includes detecting a type of material used in a surface of a pool or spa using a ToF sensor on an APCor docking station, and controlling the APC based on the detected type of material.

According to certain embodiments, a method includes detecting an occupant in a pool or spa using a ToF sensor on an APC or docking station, and controlling the APC based on the detected occupant.

According to some embodiments, an APC or docking station includes a ToF sensor system on the APC or docking station and for measuring in a plurality of directions in at least one plane defined by the APC.

According to various embodiments, a method includes receiving a plurality of measurements measured in 360° about an axis from a ToF sensor system on an APC or docking station while underwater and determining a characteristic of the APC or a pool or spa based on the plurality of measurements.

According to certain embodiments an APC or docking station includes a ToF sensor system for taking a continuous measurement in a plurality of directions relative to the APC.

According to some embodiments, an APC or docking station includes a ToF sensor system configured to take a plurality of ToF measurements around a periphery of the APC.

According to various embodiments, a method includes determining a cleaner path for an APC using continuous ToF measurement.

According to certain embodiments, an APC or docking station includes a ToF sensor system for taking measurements in a plurality of directions relative to the APC or docking station by transmitting and receiving blue light or green light.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a pool system according to embodiments.

FIG. 2 illustrates an example of real time positioning and/or mapping of an APC of the pool system of FIG. 1 in a pool of the pool system of FIG. 1 according to embodiments.

### DETAILED DESCRIPTION

Described herein are systems and methods of employing a ToF sensor system underwater, and particularly, but not limited to, in connection with the use of robotic APCs. In certain embodiments, the ToF sensor system is a LIDAR sensor system using lights and/or lasers within and/or on the APC. The systems and methods described herein may take a plurality of measurements around the APC. The systems and methods described herein may take measurements in a plurality of directions relative to the APC. In certain embodiments, the systems and methods described herein take a continuous measurement. In various embodiments, the systems and methods described herein may use a continuous measurement about at least one axis, and in some embodiments the systems and methods described herein may take continuous measurements about a plurality of axes. In certain embodiments, the continuous measurement is about an angle greater than 0°, optionally at least 180°, and/or optionally 360°. As used herein, “continuous measurement” may refer to measurements about the angle greater than 0° all at once or measurements as the sensor rotates or scans through the angle depending on the arrangement of the system. The systems and methods described herein may allow for the APC to map the pool or spa, determine a cleaner path for the APC, determine if there are occupants in the pool (for security, safety, or other reasons), avoid obstacles within the pool or spa, drive the APC towards debris, and/or drive the APC to specific areas of the pool or spa, among other actions. Various other benefits and advantages may be realized with the systems and methods provided herein, and the aforementioned advantages should not be considered limiting.

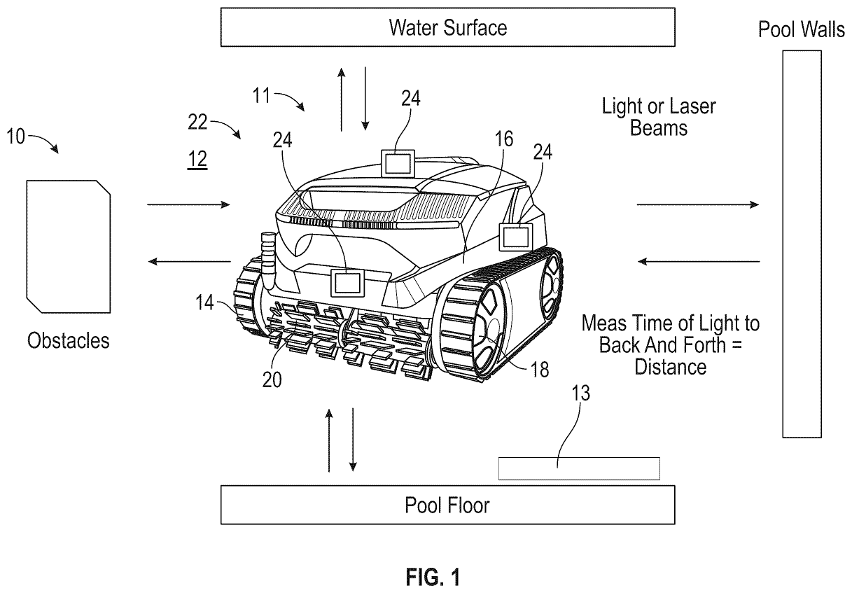

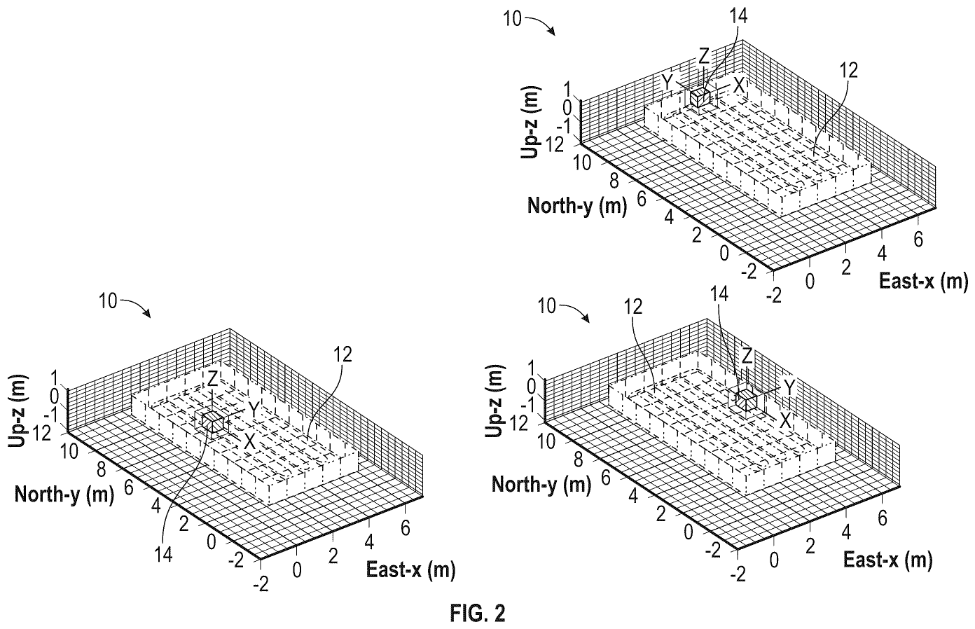

FIGS. 1 and 2 illustrate an example of a pool system 10 with a pool 12 and an APC system 11 which includes at least an APC 14 for performing various operations within the pool 12. In certain embodiments, the APC system 11 includes additional equipment for the APC 14, such as but not limited to a docking station 13 (e.g., where the APC 14 may be parked when not in use, charged, etc.). The APC 14 generally includes a body 16, one or more motive elements 18, and one or more cleaning devices (including, but not limited to, a scrubber brush 20). In certain embodiments, the APC 14 is a cordless APC 14 and includes an onboard power source such as but not limited to one or more batteries, but in other embodiments the APC 14 may have a cord for connection with an external power source. A motor, pump, filter, controller (e.g., processor and/or memory), communication modules, and various other features may be provided on or within the APC 14 as desired. Other non-limiting examples of APCs 14 may include those described in U.S. Pat. Nos. 10,316,534, 9,488,154, 8,578,538, and U.S. Patent Publication No. 2014/0303810, all of which are hereby incorporated by reference in their entireties. The docking station 13 may include various features for engaging and/or otherwise interfacing with the APC 14, such as but not limited to a docking surface with one or more ribs or support features, components or systems for charging the APC 14, etc. The particular location of the docking station 13 illustrated in FIG. 1 should not be considered limiting, as in various embodiments, the docking station 13 may be provided on a submerged surface within the pool 12 (e.g., a floor, sidewall, beach, bench, stair, etc.) and/or may be provide external to the pool 12 (e.g., on a pool deck).

In various embodiments, one or more components of the APC system 11 includes a ToF sensor system 22. As non-limiting examples, the APC 14 and/or the docking station 13 may include a ToF sensor system 22 (e.g., a light-based ToF sensor system, a laser-based ToF sensor system, etc.). Thus, while the below description is made in the context of the APC 14 including the ToF sensor system 22, the following description is equally applicable to the docking station 13 with a ToF sensor system 22.

In certain embodiments, the ToF sensor system 22 may continuously collects data in a plurality of directions relative to the APC 14 and/or about a periphery of the APC 14. In some embodiments, the ToF sensor system 22 may continuously collect data by performing continuous measurements about an angle greater than 0° relative to one or more axis of the APC 14. As non-limiting examples, the ToF sensors 22 may continuously collect data about an angle greater than 0°, such as greater than or equal to 10°, greater than or equal to 20°, greater than or equal to 30°, greater than or equal to 40°, greater than or equal to 50°, greater than or equal to 60°, greater than or equal to 70°, greater than or equal to 80°, greater than or equal to 90°, greater than or equal to 100°, greater than or equal to 110°, greater than or equal to 120°, greater than or equal to 130°, greater than or equal to 140°, greater than or equal to 150°, greater than or equal to 160°, greater than or equal to 170°, greater than or equal to 180°, etc. As further non-limiting examples, the angle may be from greater than 0° to about 360°, such as from about 10° to about 350°, such as from about 20° to about 340°, such as from about 30° to about 330°, such as from about 40° to about 320°, such as from about 50° to about 310°, such as from about 60° to about 300°. In other non-limiting examples, the angle may be from about 180° to about 360°, such as from about 190° to about 350°, such as 200° to about 340°, such as about 210° to about 330°, such as about 220° to about 320°, such as about 230° to about 310°, such as about 240° to about 300°, such as about 250° to about 290°, such as about 260° to about 280°, such as about 270°. In one non-limiting example, the ToF sensor system 22 may perform continuous 360° measurements about one or more axis of the APC 14 (e.g., continuous 360° measurements about an x axis of the APC (front-to-back axis), continuous 360° measurements about a y axis of the APC (side-to-side axis), and/or continuous 360° measurements about a z axis of the APC (up-and-down axis), etc.). In the embodiment illustrated in FIGS. 1 and 2, the ToF sensor system 22 performs continuous measuring about each of the x axis, the y axis, and the z axis of the APC 12. In other embodiments, the ToF sensor system 22 may perform measurements about a single axis and/or any other combination of axis as desired.

The ToF sensor system 22 may include various suitable ToF sensors 24. The ToF sensors 24 may include one or more emitters and one or more receivers for sending and receiving signals underwater for sensing ToF (represented by arrows in FIG. 1). As one non-limiting example, the ToF sensors 24 may transmit and receive infrared radiation and/or may transmit and receive visible light. In other embodiments, the ToF sensors 24 may include any light, whether visible to the human eye or not. In certain embodiments, transmitting and receiving light in the visible spectrum may be advantageous, especially in the relatively clear water of swimming pools and spas. In various embodiments, the light used by the ToF sensors 24 described herein may be used to affect and/or control accuracy and/or range. In some non-limiting examples, the ToF sensors 24 described herein may use various colors of light to affect and/or control accuracy and/or range of the sensors. As a non-limiting example, the ToF sensors 24 described herein may use light that is the color blue or the color green. Blue and/or green light used by ToF sensors 24 may be advantageous, especially in the relatively clear water of swimming pools and spas.

The ToF sensors 24 may be provided in various arrangements and/or configurations for performing continuous measurements. As one non-limiting example, the ToF sensor system 22 includes a ToF sensor 24 that rotates relative to the APC 14 and continuously collects data as the ToF sensor 24 rotates. As an example, the ToF sensor system 22 is a LIDAR sensor system with a rotating laser or light sensor on the APC 14. As another non-limiting example, the ToF sensor system 22 includes a ToF sensor 24 that is static relative to the APC 14 and additionally includes a rotating mirror. As an example, the ToF sensor system 22 is a LIDAR sensor system with a static laser or light sensor with a rotating mirror for changing a direction of the laser or light as the mirror rotates. As yet another non-limiting example, the ToF sensor system 22 may include a plurality of ToF sensors 24 on or within the APC 14 for covering all around the APC 14 (e.g., around a periphery of the APC 14). As an example, the ToF sensor system 22 is a LIDAR sensor system with a plurality of laser or light sensors provided at various locations on the APC for continuously measuring around the APC 14. In other embodiments, the ToF sensor system 22 may include other suitable ToF sensors and/or combinations thereof. In the embodiment of FIGS. 1 and 2, the APC 14 includes rotating ToF sensors 24 for continuous measuring as the ToF sensors 24 rotate through 360° about each of the x axis, y axis, and z axis. The number and locations of the ToF sensors 24 illustrated should not be considered limiting.

Additionally, or alternatively, one or more ToF sensors 24 need not be rotatable relative to the APC 14, and the ToF sensors 24 are stationary relative to the APC 14. In such embodiments, the APC 14 may be rotatable, and rotating of the APC 14 may facilitate the ToF sensor 24 performing measurements by the ToF sensory system 22 about an angle greater than 0°.

Information sensed by the ToF sensor system 22 while underwater (e.g., time for the light or laser to reflect off a surface, amplitude of reflected light or laser, intensity of reflected light or laser, etc.) may be used by the APC 14 to determine various information about the APC 14 and/or the pool 12. In such embodiments, the ToF sensor system 22 may be communicatively coupled with a controller of the APC 14 such that the sensed information from the ToF sensor system 22 may be provided to the controller. Such a controller may be on-board the APC 14 or remote from the APC 14 as desired.

As non-limiting examples, the sensed information obtained by the continuous measurements may be used to determine various kinematic and/or dynamic information about the APC 14, such as but not limited to position of the APC 14, speed of the APC 14, acceleration of the APC 14, direction of movement of the APC 14, orientation of the APC 14, surface on which the APC 14 is positioned (e.g., floor, wall, step, etc.), filter status, power level, cleaning cycle time, forces applied, sub-combinations thereof, and/or other information as desired. As another non-limiting example, the sensed information obtained by the continuous measurements may be used to determine a distance from the APC 14 to a wall, a floor, or other underwater obstacle. As a further non-limiting example, the sensed information obtained by the continuous measurements may detect debris within the pool 12. As another non-limiting example, the continuous measurements may detect debris outside of the pool 12. As an additional non-limiting example, the sensed information obtained by the continuous measurements may detect distance, orientation, movement, etc. of the APC 14 relative to the docking station 13. As a further non-limiting example, the sensed information may be used to determine an angle at which the APC 14 is moving towards or away from the wall, the floor, or other underwater obstacle. In various embodiments, because the ToF sensor system 22 is continuously measuring, the sensed information may be used to determine a distance of the APC 14 from all surfaces of the pool 12 (e.g., wall surface, floor surface, water surface, etc.). In some embodiments, the continuous measurements from the ToF sensor system 22 may be used to determine a 2D and/or 3D shape of the pool 12. The sensed information obtained by the continuous measurements may be used to determine a presence or absence of occupants within the pool 12. In certain embodiments, the sensed information may be used to determine a type of materials used in a surface of the pool 12 (e.g., liner, concrete, stone, etc.). In some embodiments, the APC 14 may determine such information based on the sensed information, although in other embodiments it need not, and the information may be communicated to a remote device or system. Moreover, such determinations may be made in real time and/or at a later time as desired.

In some embodiments, based on the sensed information from the ToF sensor system 22 and/or the information determined based on the sensed information, the APC 14 may perform various operations while the APC 14 is underwater in a pool or spa and/or may perform a future operation of the APC 14. In such embodiments, the controller may perform various operations and/or cause the APC 14 to perform various operations based on the sensed information from the ToF sensor system 22.

As a non-limiting example, the controller of the APC 14 may generate a map of the pool 12 based on the sensed information from the ToF sensor 22. As another non-limiting example, the controller of the APC 14 may generate and/or determine a cleaner path or pattern for the APC 14 within the pool 12, and optionally cause the APC 14 to follow the cleaner path or pattern. In another non-limiting example, the controller of the APC 14 may optimize and/or adjust a cleaning pattern based on the sensed information. As a further non-limiting example, the APC 14 may be controlled to return to a certain spot or area within the pool 12, and/or the APC 14 may be controlled to avoid obstacles within the pool 12. In another non-limiting example, based on a detection of the type of materials used in a surface of the pool 12 from the sensed information, the APC 14 may adapt and/or control its motors, sensors, pattern strategies, etc. based on the materials. As another non-limiting example, the APC 14 may avoid an area of the pool 12 based on a detection of an occupant within that area from the sensed information, and later return to that area based on an absence of the occupant and/or detection that the occupant is no longer within the area. As a further non-limiting example, the APC 14 may send a notification to a remote device and/or generate an alert on the APC 14 and/or remote device based on a detection of an occupant within the pool from the sensed information. FIG. 2 illustrates an example of real time positioning and mapping of the APC 14 within the pool 12 using the continuous measurements from the ToF sensor system 22.

Various other controls and/or operations may be performed as desired, and the aforementioned examples should not be considered limiting.

Exemplary concepts or combinations of features of the invention may include: A. An APC or docking station comprising a ToF sensor system configured to perform measuring about an angle greater than 0° about at least one axis underwater.
B. The APC or docking station of any preceding or subsequent statement or combination of statements, wherein the at least one axis is an x axis of the APC or docking station.
C. The APC or docking station of any preceding or subsequent statement or combination of statements, wherein the at least one axis is a y axis of the APC or docking station.
D. The APC or docking station of any preceding or subsequent statement or combination of statements, wherein the at least one axis is a z axis of the APC or docking station.
E. The APC or docking station of any preceding or subsequent statement or combination of statements, wherein the ToF sensor system comprises a static light sensor and a rotating mirror.
F. The APC or docking station of any preceding or subsequent statement or combination of statements, wherein the ToF sensor system comprises a rotating laser.
G. The APC or docking station of any preceding or subsequent statement or combination of statements, wherein the ToF sensor system comprises a plurality of light sensors, each sensor positioned at a location on the APC or docking station.
H. The APC or docking station of any preceding or subsequent statement or combination of statements, wherein the ToF sensor system is configured to perform 360° measuring by using a rotating mirror, using a rotating laser, rotating the APC or docking station itself, and/or using a plurality of light sensors placed at a plurality of locations on the APC.
I. The APC or docking station of any preceding or subsequent statement or combination of statements, wherein the ToF sensor system is configured to measure at least one of an intensity of a light or laser beam, an amplitude of the light or laser beam, and/or control information coded by the light or laser beam.
J. The APC or docking station of any preceding or subsequent statement or combination of statements, wherein, based on the information from the ToF sensor system, the APC or docking station is configured to determine at least one of a distance from all surfaces of a pool or spa, debris within the pool, obstacles within the pool, a two dimensional shape of the pool or spa, a three dimensional shape of the pool or spa, and/or one or more operating characteristics of the APC or docking station.
K. The APC or docking station of any preceding or subsequent statement or combination of statements, wherein the one or more operating characteristics comprises a position of the APC, a speed of the APC, an acceleration of the APC, forces applied by the APC, or a direction of movement of the APC.
L. The APC or docking station of any preceding or subsequent statement or combination of statements, wherein the APC or docking station is configured to generate an output based on the information from the ToF sensor system.
M. The APC or docking station of any preceding or subsequent statement or combination of statements, wherein the APC or docking station is configured to control the APC as the output by adjusting a cleaning pattern, causing the APC to move to a location, causing the APC to move toward debris, and/or causing the APC to avoid obstacles.
N. The APC or docking station of any preceding or subsequent statement or combination of statements, wherein the APC is configured to determine a type of material of a surface of the pool or spa based on the information from the ToF sensor system.
O. The APC or docking station of any preceding or subsequent statement or combination of statements, wherein the APC is configured to detect a presence of an occupant in the pool or spa based on the information from the ToF sensor system.
P. An APC or docking station comprising a ToF sensor system configured to perform 360° measuring about three axes while underwater.
Q. A method of mapping a pool or spa comprising moving an APC within the pool or spa, the APC comprising a ToF sensor system configured to perform 360° measuring about three axes while underwater.
R. A method comprising locating an APC or docking station within a swimming pool or spa based on ToF measuring performed in 360° about three axes.
S. A method comprising detecting a type of material used in a surface of a pool or spa using a ToF sensor on an APC or docking station, and controlling the APC based on the detected type of material.
T. A method comprising detecting an occupant in a pool or spa using a ToF sensor on an APC or docking station, and controlling the APC or docking station based on the detected occupant.
U. An APC or docking station comprising a ToF sensor system on the APC or docking station and for measuring in a plurality of directions in at least one plane defined by the APC or docking station.
V. A method comprising receiving a plurality of measurements measured in 360° about an axis from a ToF sensor system on an APC or docking station while underwater and determining a characteristic of the APC or docking station or a pool or spa based on the plurality of measurements.
W. An APC or docking station comprising a ToF sensor system for taking a continuous measurement in a plurality of directions relative to the APC or docking station.
X. An APC or docking station comprising a ToF sensor system configured to take a plurality of ToF measurements around a periphery of the APC or docking station.
Y. A method comprising determining a cleaner path for an APC or docking station using continuous 360° ToF measurement.
Z. An APC or docking station comprising a ToF sensor system for taking measurements in a plurality of directions relative to the APC by transmitting and receiving blue light or green light.
AA. An APC system for a swimming pool or spa, the APC system comprising at least one of an APC or a docking station for the APC, and the APC system further comprising a ToF sensor system configured to perform continuous measuring about an angle greater than 0° relative to at least one axis underwater.
BB. The APC system of any preceding or subsequent statement or combination of statements, wherein the angle is at least 10°.
CC. The APC system of any preceding or subsequent statement or combination of statements, wherein the angle is at least 180°.
DD. The APC system of any preceding or subsequent statement or combination of statements, wherein the angle is 360°.
EE. The APC system of any preceding or subsequent statement or combination of statements, wherein the angle is from 1800 to 360°.
FF. The APC system of any preceding or subsequent statement or combination of statements, wherein the ToF sensor system is a LIDAR sensor system.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with APCs, persons skilled in the relevant field will recognize that the present invention conceivably could be employed in connection with other objects and in other manners. Finally, references to “pools” and “swimming pools” herein may also refer to spas or other water containing vessels used for recreation or therapy and for which cleaning of debris is needed or desired.

That which is claimed:

1. An automatic pool cleaner (APC) system for a swimming pool or spa, the APC system comprising at least one of an APC or a docking station for the APC, and the APC system further comprising a time of flight (ToF) sensor system on at least one of the APC or the docking station and configured to perform continuous measuring about an angle greater than 0° relative to at least one axis underwater.

2. The APC system of claim 1, wherein the ToF sensor system is configured to perform continuous measuring about three axes while underwater.

3. The APC system of claim 1, wherein the ToF sensor system comprises a static light sensor and a rotating mirror.

4. The APC system of claim 1, wherein the ToF sensor system comprises a rotating laser.

5. The APC system of claim 1, wherein the ToF sensor system comprises a plurality of light sensors, each sensor positioned at a location on the APC.

6. The APC system of claim 1, wherein the ToF sensor system is configured to perform 360° measuring by using a rotating mirror, using a rotating laser, rotating the APC itself, and/or using a plurality of light sensors placed at a plurality of locations on the APC.

7. The APC system of claim 1, wherein the ToF sensor system is configured to measure at least one of an intensity of a light or laser beam, an amplitude of the light or laser beam, and/or control information coded by the light or laser beam.

8. The APC system of claim 1, wherein, based on information from the ToF sensor system, the APC is configured to determine at least one of a distance from all surfaces of a pool or spa, a two-dimensional shape of the pool or spa, a three-dimensional shape of the pool or spa, and/or one or more operating characteristics of the APC.

9. The APC system of claim 8, wherein the one or more operating characteristics comprises a position of the APC, a speed of the APC, an acceleration of the APC, forces applied by the APC, or a direction of movement of the APC.

10. The APC system of claim 1, wherein the APC is configured to generate an output based on information from the ToF sensor system.

11. The APC system of claim 10, wherein the APC is configured to control the APC as the output by adjusting a cleaning pattern, causing the APC to move to a location, and/or causing the APC to avoid obstacles.

12. The APC system of claim 1, wherein the APC is configured to determine a type of material of a surface of the pool or spa or detect debris based on the information from the ToF sensor system.

13. The APC system of claim 1, wherein the APC is configured to detect a presence of an occupant in the pool or spa based on the information from the ToF sensor system.

14. The APC system of claim 1, wherein the ToF sensor system is configured to transmit and receive blue light or green light.

15. A method of mapping a pool or spa comprising moving an automatic pool cleaner (APC) within the pool or spa, the APC comprising a ToF sensor system configured to perform continuous measuring about an angle greater than 0° about three axes while underwater.

16. The method of claim 15, further comprising locating the APC within the pool or spa based on the ToF sensor system measuring performed in 360° about three axes.

17. The method of claim 15, wherein 360° measuring about three axes while underwater comprises transmitting and receiving blue light or green light.

18. The method of claim 15, further comprising determining a characteristic of the APC or a pool or spa based on a plurality of measurements.

19. The method of claim 15, further comprising determining a cleaner path for the APC using continuous 360° ToF measurement.

20. A method comprising at least one of:
a. detecting a type of material used in a surface of a pool or spa using a ToF sensor on an automatic pool cleaner (APC), and controlling the APC based on the detected type of material; or
b. detecting an occupant in a pool or spa using the ToF sensor on the APC, and controlling the APC based on the detected occupant.
